(19) United States
(12) Patent Application Publication
(10) Pub. No.: US 2017/0187819 A1
(43) Pub. Date: Jun. 29, 2017

(54) NEGOTIATING PROXY SERVER FOR DISTRIBUTED STORAGE AND COMPUTE CLUSTERS

(71) Applicant: Nexenta Systems, Inc., Santa Clara, CA (US)

(72) Inventors: Alexander AIZMAN, Mountain View, CA (US); Caitlin BESTLER, Sunnyvale, CA (US)

(21) Appl. No.: 14/983,386

(22) Filed: Dec. 29, 2015

(51) Int. Cl. H04L 29/08; H04L 12/18

(52) U.S. Cl. CPC H04L 67/2833; H04L 12/18; H04L 67/1097

(57) ABSTRACT

The present invention defines a new type of negotiating proxy server which optimizes a multi-node collaboration of distributed servers, where the goal of the negotiation is to synchronize rendezvous interactions between the initiator and subsets of servers in multicast groups. For example, in distributed storage clusters servers commit to receiving and then storing a chunk of data in parallel at a specified time, while in compute clusters servers perform one portion of a calculation in parallel. Negotiating proxy server optimizes these interactions as disclosed herein.

### TECHNICAL FIELD

The present invention relates to a method for proxying negotiation of a multi-party transactional collaboration within a distributed storage and/or compute cluster using multicast messaging. For example, a negotiating proxy server can be used to facilitate put transactions in a distributed object storage system or to facilitate computations in a compute cluster. In one embodiment, the negotiating proxy server is associated with a negotiating group comprising a plurality of storage servers, and the negotiating proxy server can respond to put requests from a initiator or application layer gateway for one or more of the plurality of storage servers. The negotiating proxy server facilitates earlier negotiation of the eventual storage transfers, but does not participate in any of those transfers. In another embodiment, the negotiating proxy server is associated with a negotiating group comprising a plurality of computation servers, and the negotiating proxy server can respond to compute requests from an initiator for one or more of the plurality of computation servers. The negotiating proxy server facilitates earlier negotiation of the compute task assignments, but does not participate in any of the computations.

### BACKGROUND OF THE INVENTION

This application builds upon the inventions by Applicant disclosed in the following patents and applications: U.S. patent application Ser. No. 14/258,791, filed on Apr. 22, 2014 and titled “SYSTEMS AND METHODS FOR SCALABLE OBJECT STORAGE”; U.S. patent application Ser. No. 14/258,791 is: a continuation of U.S. patent application Ser. No. 13/624,593, filed on Sep. 21, 2012, titled “SYSTEMS AND METHODS FOR SCALABLE OBJECT STORAGE,” and issued as U.S. Pat. No. 8,745,095; a U.S. patent application Ser. No. 13/209,342, filed on Aug. 12, 2011, titled “CLOUD STORAGE SYSTEM WITH DISTRIBUTED METADATA,” and issued as U.S. Pat. No. 8,533,231; U.S. patent application Ser. No. 13/415,742, filed on Mar. 8, 2012, titled “UNIFIED LOCAL STORAGE SUPPORTING FILE AND CLOUD OBJECT ACCESS” and issued as U.S. Pat. No. 8,849,759; U.S. patent application Ser. No. 14/095,839, which was filed on Dec. 3, 2013 and titled “SCALABLE TRANSPORT SYSTEM FOR MULTICAST REPLICATION”; U.S. patent application Ser. No. 14/095,843, which was filed on Dec. 3, 2013 and titled “SCALABLE TRANSPORT SYSTEM FOR MULTICAST REPLICATION”; U.S. patent application Ser. No. 14/095,848, which was filed on Dec. 3, 2013 and titled “SCALABLE TRANSPORT WITH CLIENT-CONSENSUS RENDEZVOUS”; U.S. patent application Ser. No. 14/095,855, which was filed on Dec. 3, 2013 and titled “SCALABLE TRANSPORT WITH CLUSTER-CONSENSUS RENDEZVOUS”; U.S. Patent Application No. 62/040,962, which was filed on Aug. 22, 2014 and titled “SYSTEMS AND METHODS FOR MULTICAST REPLICATION BASED ERASURE ENCODING;” U.S. Patent Application No. 62/098,727, which was filed on Dec. 31, 2014 and titled “CLOUD COPY ON WRITE (CCOW) STORAGE SYSTEM ENHANCED AND EXTENDED TO SUPPORT POSIX FILES, ERASURE ENCODING AND BIG DATA ANALYTICS”; and U.S. patent application Ser. No. 14/820,471, which was filed on Aug. 6, 2015 and titled “Object Storage System with Local Transaction Logs, A Distributed Namespace, and Optimized Support for User Directories.”

All of the above-listed application and patents are incorporated by reference herein and referred to collectively as the “incorporated references.”

The present invention introduces a negotiating proxy server to clusters which use multicast communications to dynamically select from multiple candidate servers based on distributed state information. Negotiations are useful when the state of the servers will influence optimal assignment of resources. The longer a task runs, the less important the current state of individual servers is. Thus, negotiations are more useful for short transactions and less so for long transactions. Multicast negotiations are more specialized negotiations. Multicast negotiations are useful when the information required to schedule resources is distributed over many different servers. A negotiating proxy server therefore is particularly relevant when multicast negotiations are desirable for a particular application.

One example of multicast system is disclosed in the incorporated references. Multicast communications are used to select the storage servers to hold a new chunk, or to retrieve a chunk without requiring central tracking of the location of each chunk. The multicast negotiation enables dynamic load-balancing of both storage server TOPS (input/output operations per second) and network capacity. The negotiating proxy server reduces latency for such storage clusters by avoiding head-of-line blocking of control plane packets.

Another example would be an extension of such a multicasting storage system in a manner that supports on-demand hyper-converged calculations. Each storage server would be capable of accepting guest jobs to perform job-specific steps on a server where all or most of the input data required was already present. The Hadoop system for MapReduce jobs already does this type of opportunistic scheduling of compute jobs on locations closest to the input data. It moves the task to the data rather than moving the data to the task. Hadoop's data is controlled by HDFS (Hadoop Distributed File System) which has centralized metadata, so Hadoop would not benefit from multicast negotiations as it is currently designed.

The technique of moving the task to where the data already is located could be applied to a computer cluster. Instead of multicasting a request to store chunk X to a multicast negotiating group, the request could be extended to multicasting a request to calculate a chunk. This extended request would specify the algorithm and the input chunks for the calculation. Each extended storage server would bid on when it could complete such a calculation. Servers that already had a copy of the input chunks would obviously be at an advantage in preparing the best bid. The algorithm could be specified by any of several means, including using an enumerator, a URL of executable software or the chunk id of executable software

Generically, a negotiating proxy server can be useful for any cluster which engages in multicast negotiations to allocate resources and can reduce latency in determining the participants for a particular activity within the cluster. Additionally, the following guidelines are important to provide the negotiating proxy server with a reasonable prospect of optimizing negotiations:
It must be feasible for the negotiating proxy server to track enough data for each server in a multicast group for which it is proxying so that the negotiating proxy server can preemptively accept on behalf of the server at least a substantial portion of the time.
Any extra communications required to supply this information to the negotiating proxy server must be minimal or preferably non-existent. Use of multicast addressing minimizes the additional impact of delivering a datagram to one additional target. Because delivery is concurrent, delivering to an extra target only increases the time required if the delivery to that extra target happens to take the longest time of all the targets.
Communications between the client and the target servers should not be delayed due to the use of the negotiating proxy server.
   A full system where a negotiating proxy server is applicable therefore comprises a plurality of initiating agents which request work from a set of servers. The initiating agents operate in parallel and without centralized synchronization. The task to be performed consists of a sequence of steps to be performed by the scheduled servers. Local conditions, such as current work queue depths and whether a specific server has a given input chunk already locally cached, impact the time required to perform the requested tasks.

When no optimizing negotiating proxy server is involved, the initiating agent will orchestrate each task by:
Multicasting a request asking for bids from the servers in a multicast group.
Collecting the responses from the addressed servers and selecting a specific set to perform the required task. Alternately, the servers themselves could share their information and select the target servers via agreed-upon algorithms. An example of this option is described under the group consensus options in the incorporated references.
Multicasting a message to the group specifying the specific servers assigned to perform the request at specific times. Typically, this will release tentative resource reservations made for the original request but which were not selected.
Performing content transfers or accepting results as specified in the accept message.

With reference now to existing relevant art, FIG. 1 depicts storage system 100 described in the incorporated references. Storage system 100 comprises clients 110a, 110b, . . . 110i (where i is any integer value), which access initiator/application layer gateway 130 over client access network 120. It will be understood by one of ordinary skill in the art that there can be multiple gateways and client access networks, and that gateway 130 and client access network 120 are merely exemplary. Gateway 130 in turn accesses replicast network 140, which in turn accesses storage servers 150a, 150b,150c, 150d, . . . 150k (where k is any integer value). Each of the storage servers 150a, 150b,150c, 150d, . . . , 150k is coupled to a plurality of storage devices 160a, 160b, . . . 160k, respectively.

In this patent application the terms “initiator”, “application layer gateway”, or simply “gateway” refer to the same type of devices and are used interchangeably. FIG. 2 depicts a typical put transaction in storage system 100 to store chunk 220. As discussed in the incorporated references, groups of storage servers are maintained, which are referred to as “negotiating groups.” Here, exemplary negotiating group 210a is depicted, which comprises ten storage servers, specifically, storage servers 150a-150j. When a put command is received, gateway 130 assigns the put transaction to a negotiating group. In this example, the put chunk 220 transaction is assigned to negotiating group 210a. It will be understood by one of ordinary skill in the art that there can be multiple negotiating groups on storage system 100, and that negotiating group 210a is merely exemplary, and that each negotiating group can consist of any number of storage servers and that the use of ten storage servers is merely exemplary.

Gateway 130 then engages in a protocol with each storage server in negotiating group 210a to determine which three storage servers should handle the put request. The three storage servers that are selected are referred to as a “rendezvous group.” As discussed in the incorporated references, the rendezvous group comprises three storage servers so that the data stored by each put transaction is replicated and stored in three separate locations, where each instance of data storage is referred to as a replica. Applicant has concluded that three storage servers provide an optimal degree of replication for this purpose, but any other number of servers could be used instead.

In varying embodiments, the rendezvous group may be addressed by different methods, all of which achieve the result of limiting the entities addressed to the subset of the negotiating group identified as belonging to the rendezvous group. These methods include:
Selecting a matching group from a pool of pre-configured multicast groups each holding a different subset combination of members from the negotiating group.
Using a protocol that allows each UDP message to be addressed to an enumerated subset of the total group. An example of such a protocol would be the BIER protocol currently under development by the IETF.
Using a custom control protocol which allows the sender to explicitly specify the membership of a target multicast group as being a specific subset of an existing multicast group. Such a control protocol was proposed in an Internet Draft submitted to the IETF titled “Creation of Transactional Multicast Groups” and dated Mar. 23, 2015, a copy of which is being submitted with this application and is incorporated herein by reference.

In FIG. 3, gateway 130 has selected storage servers 150b, 150e, and 150g as rendezvous group 310a to store chunk 220.

In FIG. 4, gateway 130 transmits the put command for chunk 220 to rendezvous group 310a. This is a multicast operation.

As discussed in the incorporated references, and as shown in FIGS. 1-4, storage system 100 has many advantages over central scheduling servers of the prior art. Many clusters follow an architecture that requires that each task be assigned to a set of servers on a transactional basis. Over the course of an hour, each server will perform tasks for hundreds or thousands of different clients, but each transaction requires a set of servers that has available resources to be assigned to work upon a specific task. In a storage cluster, an exemplary task may be accepting a multicast transmission of a chunk to be stored and then saving that chunk to persistent storage. In a computational cluster, an exemplary task may be to perform one slice of a parallel computation for a client that has dynamically submitted a job. The storage cluster wants multiple servers working on the transaction to achieve multiple independent persistent replicas of the content. The computational cluster needs multiple processors to provide a prompt response to an ad hoc query. Both need a multi-party collaboration to determine the optimal set of servers to perform a specific collaboration.

Multicast communications, as used in storage system 100, can be favorably compared to the prior art in identifying servers that have available resources. When the work performed by each server to complete a task is variable, it becomes problematic for a prior art central scheduler to track what each server has cached, exactly how fast each write queue is draining or exactly how many iterations are required to find the optimal solution to a specific portion of an analysis. Having each server bid to indicate its actual resource availability applies market economics to the otherwise computationally complex problem of finding the optimal set of resources to be assigned. This is in addition to the challenge of determining the work queue for each storage server when work requests are coming from a plurality of gateways.

However, it is sometimes challenging for the servers to promptly respond with bids. Storage servers may already be receiving large payload packets, delaying their reception of new requests offering future tasks. A computational server may be devoting all of its CPU cycles to the current task and not be able to evaluate a new bid promptly.

Thus, one drawback of the architecture described in the incorporated references and FIGS. 1-4 herein, is that certain inefficiencies can result based on payload transmissions. For example, in FIG. 5, during the negotiation phase for put chunk 220, a put of payload 510 is in process for storage server 150a. If payload 510 is relatively large (e.g., a jumbo frame), then substantial latency will be introduced into the negotiation process for the put of chunk 220 because storage server 150a will not receive the negotiation message for the put chunk 220 transaction until transmission of a payload frame carrying part of payload 510 is completed. The specific traffic scheduling algorithms of implementations of the embodiments of the incorporated references will minimize the depth of the network queue filled by payload frames.

The problem of payload frames delaying control plane frames would be more severe with a conventional congestion control strategy. There could be multiple payload frames in the network queue to any storage target. Similar bottlenecks can occur in the opposite direction when storage servers send messages to gateway 130 in response to the negotiation request. With the congestion control strategy (such as described in the incorporated references) the corresponding negative impact on the end-to-end latency can be minimized. However, while the delay from payload frames can be minimized, it is still present and has not been eliminated. The negotiating proxy servers optimize processing of control plane commands because payload frames are never routed to their ingress links.

This inefficiency occurs in storage system 100 because replicast network 140 carries both control packets and payload packets. The processing of payload packets can cause delays in the processing of control packets, as illustrated in FIG. 5. That is, control plane command and response packets can be stuck behind data plane transmissions (e.g., jumbo frame payload packets).

A second inefficiency of the replicast storage protocol as previously disclosed in the incorporated references is that the storage servers must make tentative reservations when issuing a response message to a received request. These tentative reservations are made by too many storage servers (the full negotiating group rather than the selected rendezvous group, typically one third the size) and for too long (the extra duration allows aligning of bids from multiple servers). While the replicast protocol will cancel or trim these reservations promptly they do result in resources being falsely unavailable for a short duration as a result of every transaction.

Prior replicast congestion control methods have attempted to minimize the number of payload packets in process to one, but subject to the constraint of never reaching zero until the entire chunk has been transferred. Because no two clocks can be perfectly synchronized, this means the architecture will occasionally risk having two Ethernet frames in process instead of risking having zero in process. But even if successfully limited to at most one jumbo frame delay per hop, these variations in the length of a replicast negotiation can add up, as there may be at least two hops per negotiating step, and at least three exchanges (put proposal requesting the put, put response containing bids, and put accept specifying the set of servers to receive the rendezvous transfer).

What is needed is an improved architecture that utilizes multicast operations and reduces the latency that can be caused in the control plane due to transmissions in the data plane.

### SUMMARY OF THE INVENTION

The present invention overcomes the inefficiencies of storage system 100 by utilizing a negotiating proxy server. As used herein, a “negotiating proxy server” is a proxy server which:
Is able to receive copies of requests sent to a set of servers seeking to negotiate a collaboration among a sub-set of the servers starting at a particular time (such as the earliest time to which all servers can agree);
Is able to respond to such a request with a proposed identification of servers to handle the underlying task and a specific time or time period to begin the task or complete the task; and
Can recognize when one or more servers have already responded to the request on their own and can suppress any proxy response as a result.

In an exemplary implementation of a negotiating proxy for a storage cluster, the negotiating proxy server receives all control data that is sent to or from a negotiating group or rendezvous group within the negotiating group, but does not receive any of the payload data. The negotiating proxy server can intervene in the negotiation process by determining which storage servers should be used for the rendezvous group and responding for those storage servers as a proxy. Those storage servers might otherwise be delayed in their response due to packet delivery delays and/or computational loads.

One exemplary usage of a negotiating proxy server is a replicast put negotiating proxy server, which may optimize a replicast put negotiation (discussed above and in the incorporated references) so as to more promptly allow a rendezvous transfer to be agreed upon, which allows a multi-party chunk delivery to occur more promptly. Replicast uses multicast messaging to collaboratively negotiate placement of new content to the subset of a group of storage targets that can accept the new content with the lowest latency. In the alternative, the same protocol can be used to perform load-balancing within a storage cluster based on storage capacity rather than to minimize transactional latency.

Using a negotiating proxy server can eliminate many of the delays discussed above by simply exchanging only control plane packets and never allowing payload packets on the links connected to the negotiating proxy server. The negotiating proxy server therefore can negotiate a rendezvous transfer at an earlier time than could have been negotiated with the full set of storage servers trying to communicate with the gateway while also processing payload jumbo frames.

Deployment of negotiating proxy servers to accelerate put negotiations can therefore accelerate at least some put negotiations and speed up those transactions. This will improve the latency of a substantial portion of the customer writes to the storage cluster.

The negotiating proxy server takes a role similar to an agent. It bids for the server more promptly that the sever can do itself, but only when it is confident that the server is available. The more complex availability questions are still left for the server to manage its bid on its own.

During operation, the negotiating proxy server optimizes assignment of servers to short term tasks that must be synchronized across multiple servers by tracking assignments to the servers and their progress on previously-assigned tasks and by only dealing with the negotiating process. The negotiating proxy server does not tie up its ports receiving payload in a storage cluster, nor does it perform any complex computations in a computational cluster. It is a booking agent, it doesn't sing or dance.

Negotiating proxy server 610 is functionally different than proxy servers of the prior art.

For example, negotiating proxy server 610 is functionally different than a prior art storage proxy. Unlike storage proxies of the prior art, negotiating proxy server 610 does not participate in any storage transfers. It cannot even be classified as a metadata server because it does not authoritatively track the location of any stored chunk. It proxies the specific transactional sequence of multicast messaging to set up a multicast rendezvous transfer as disclosed in the incorporated references. In the preferred embodiments, a negotiating proxy server 610 does not proxy get transactions. The timing of a bid in a get response can be influenced by storage server specific information, such as whether a given chunk is currently cached in RAM. There is no low cost method for a negotiating proxy server to have this information for every storage server in a negotiating group. A negotiating proxy server's best guesses could be inferior to the bids offered by the actual storage servers.

Negotiating proxy server 610 is functionally different than a prior art resource broker or task scheduler. Negotiating proxy server 610 is acting as a proxy. If it chooses not to offer a proxied resolution to the negotiation, the end parties will complete the negotiation on their own. It is acting in the control plane in real-time. Schedulers and resource brokers typically reside in the management plane. The resource allocations typically last for minutes or longer. The negotiating proxy server may be optimizing resources for very short duration transactions, such as the multicast transfer of a 128 KB chunk over a 10 Gb/sec network.

Negotiating proxy server 610 is functionally different than prior art load-balancers. Load-balancers allow external clients to initiate a reliable connection with one of N servers without knowing which server they will be connected with in advance. Load-balancers will typically seek to balance the aggregate load assigned to each of the backend servers while considering a variety of special considerations. These may include:
Application layer hints encoded in the request. For example, “L7” load-balancing switches will examine HTTP requests, especially cookies, in seeking to make an optimal assignment of a connection.
It is frequently desirable for all connections from a single client be assigned to the same server because of the possibility that the traffic on the multiple connections is related.

Negotiating proxy server 610 differs in that:
It is not handling payload.
It is selecting multiple parties, not a single server.

Negotiating proxy server 610 is functionally different than prior art storage proxies. Storage proxies attempt to resolve object retrieval requests with cached content more rapidly than the default server would have been able to respond. Negotiating proxy server 610 differs in that it never handles payload.

Negotiating proxy server 610 is functionally different than metadata servers. Metadata servers manage metadata in a storage server, but typically never see the payload of any file or object. Instead they direct transfers between clients and block or object servers. Examples include a pNFS metadata server and an HDFS namenode.

Negotiating proxy server 610 is different than a prior art proxy server used in a storage cluster. Negotiating proxy server 610 never is the authoritative source of any metadata. It merely speeds a given proxy. Each storage server still retains control of all metadata and data that it stores.

### BRIEF DESCRIPTION OF THE DRAWINGS

FIG. 1 depicts a storage system described in the incorporated references.

FIG. 2 depicts a negotiating group comprising a plurality of storage servers.

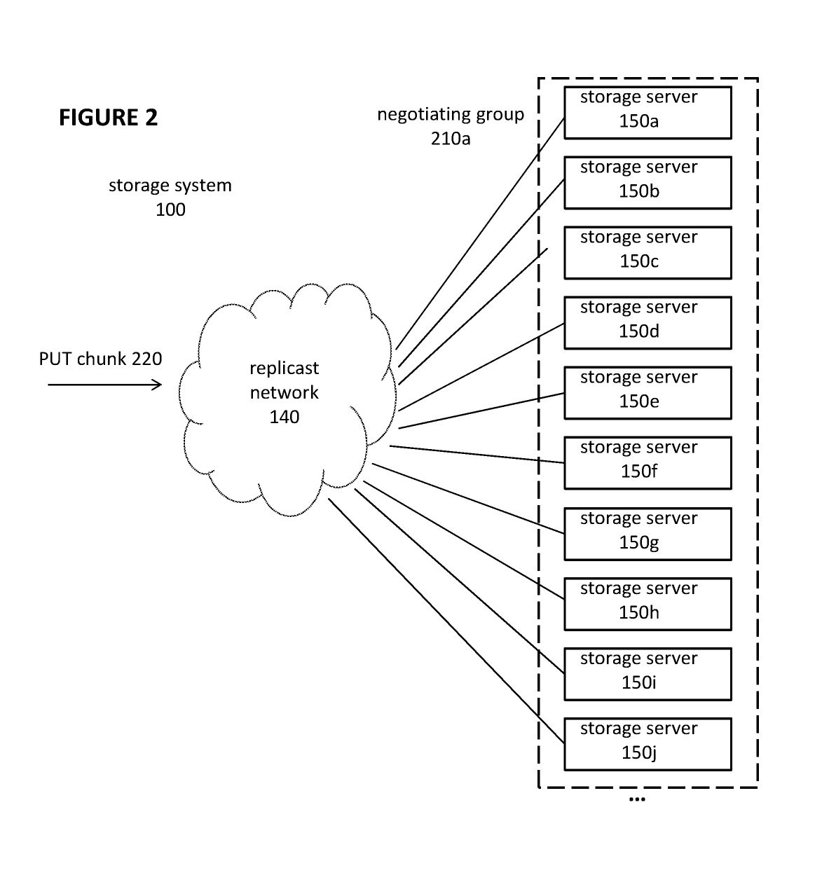

FIG. 3 depicts a rendezvous group formed within the negotiating group.

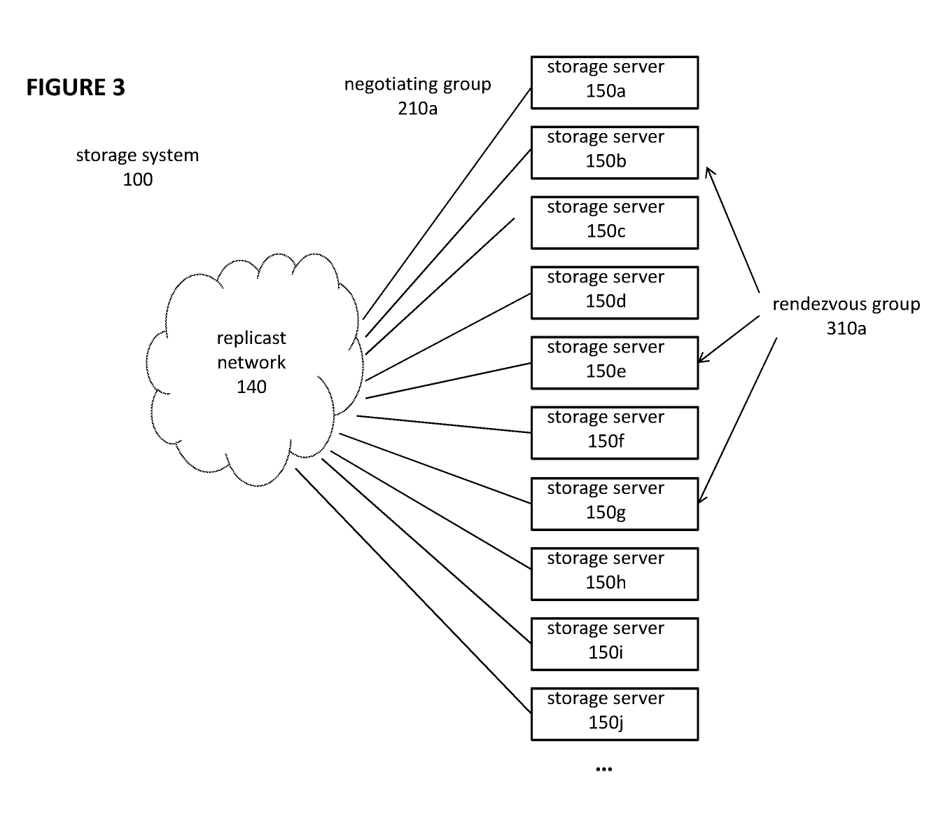

FIG. 4 depicts a put transaction of a chunk to the rendezvous group.

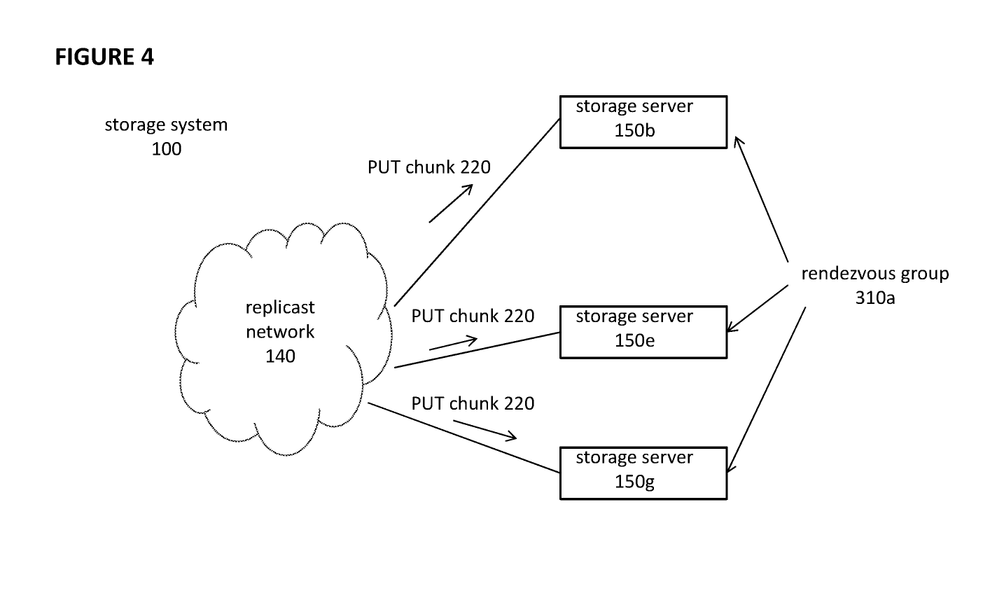

FIG. 5 depicts congestion during the negotiation process due to the storage of a large payload to a storage server.

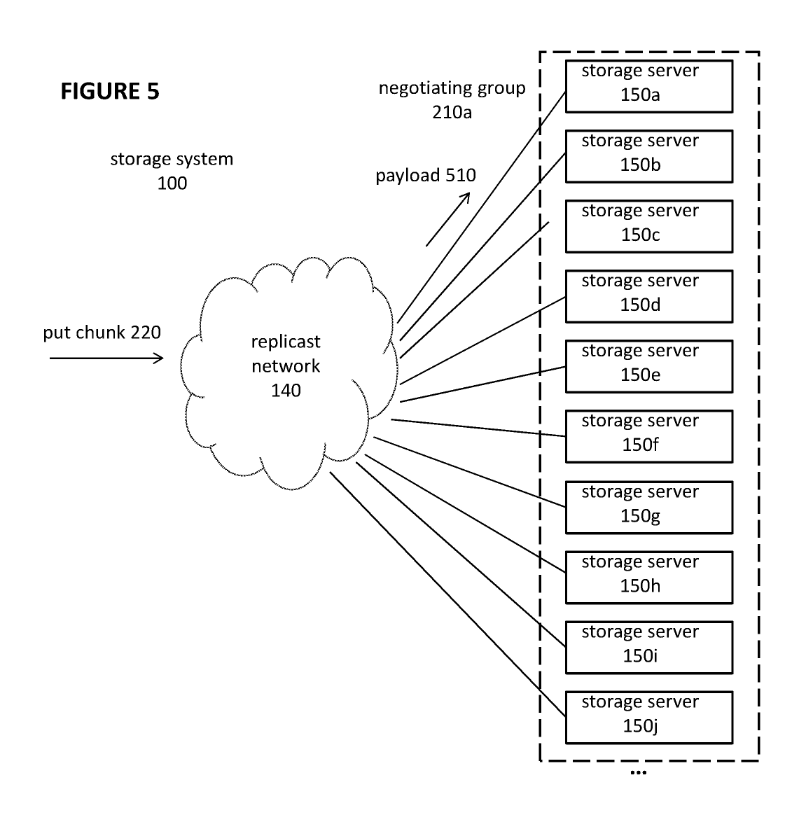

FIG. 6 depicts an embodiment of a storage system comprising a negotiating proxy server for a negotiating group.

FIG. 7 depicts the relationships between a storage server, negotiating group, and negotiating proxy server.

FIG. 8 depicts a negotiating proxy server intervening during the negotiation process for a put transaction.

FIG. 9 depicts a put transaction of a chunk to the rendezvous group established by the negotiating proxy server.

FIG. 10 depicts a storage system comprising a negotiating proxy server and a standby negotiating proxy server.

FIG. 11 depicts a system and method for implementing a negotiating proxy server.

FIG. 12 depicts an exemplary put transaction without the use of a negotiating proxy server.

FIG. 13 depicts an exemplary put transaction where negotiating proxy server pre-empts put responses from storage servers.

FIG. 14 depicts an exemplary put transaction with duplicate override.

FIG. 15 depicts an exemplary generic multicast transactions of the type that a negotiating proxy server can optimize.

FIG. 16 depicts an exemplary generic multicast transaction that has been optimized by a negotiating proxy server.

FIG. 17 depicts state diagram for a put transaction from the perspective of a gateway.

FIG. 18 depicts hardware components of an embodiment of a negotiating proxy server.

FIG. 19 depicts an embodiment of a system comprising a negotiating proxy server for a negotiating group.

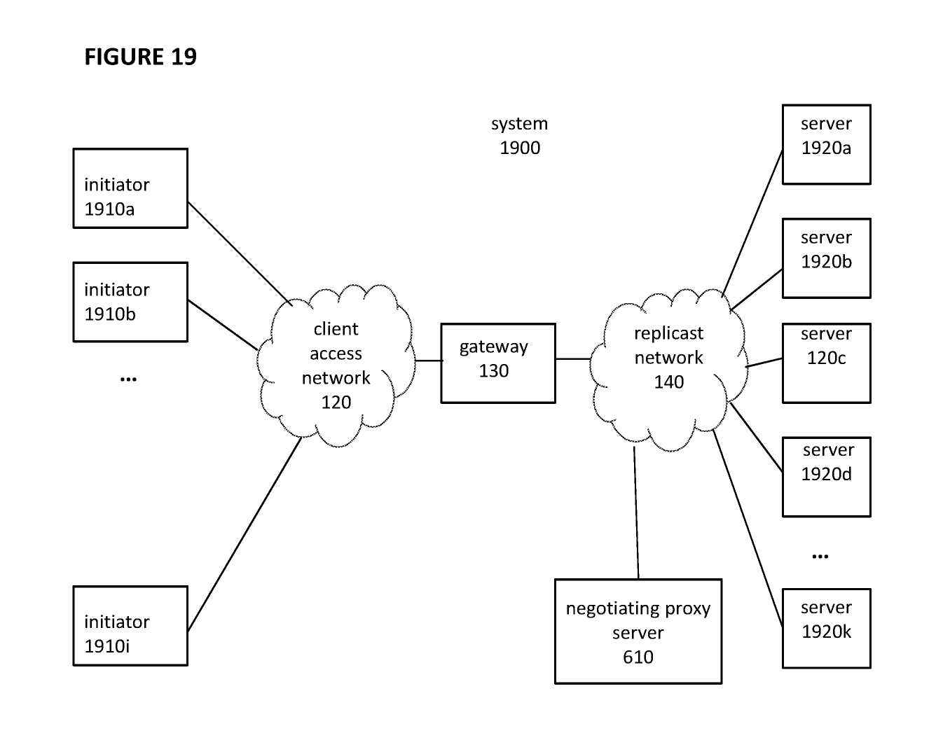

### DETAILED DESCRIPTION OF THE PREFERRED EMBODIMENTS

The embodiments described below involve storage systems comprising one or more negotiating proxy servers.

Overview of Exemplary Use of Negotiating Proxy Server

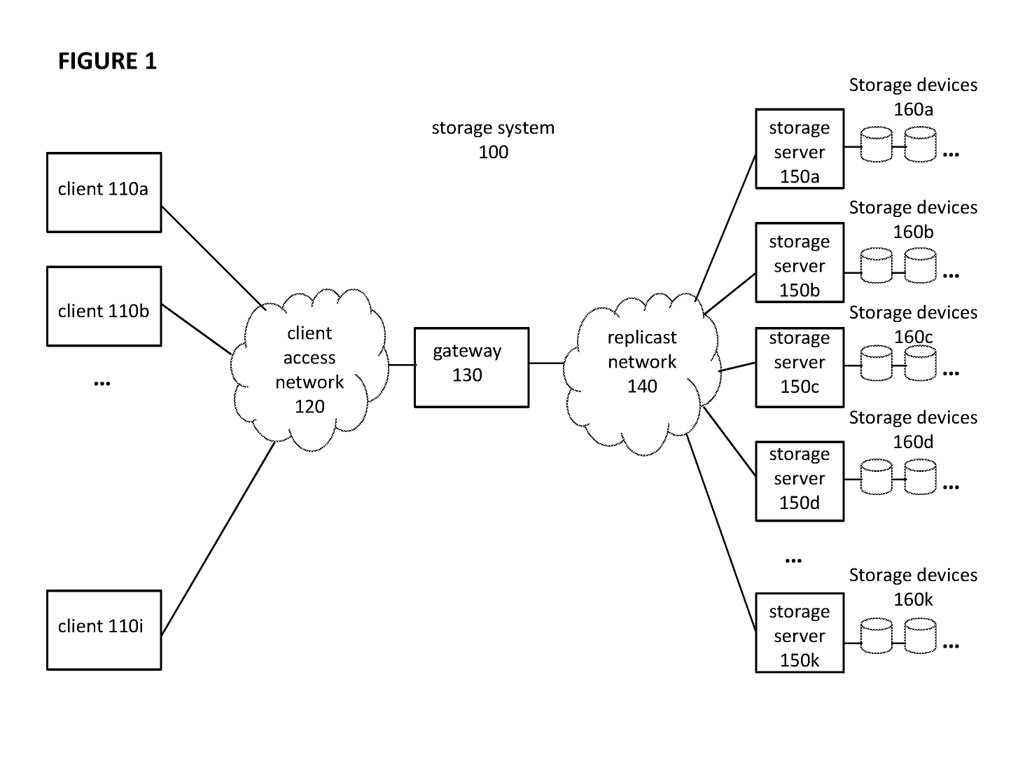

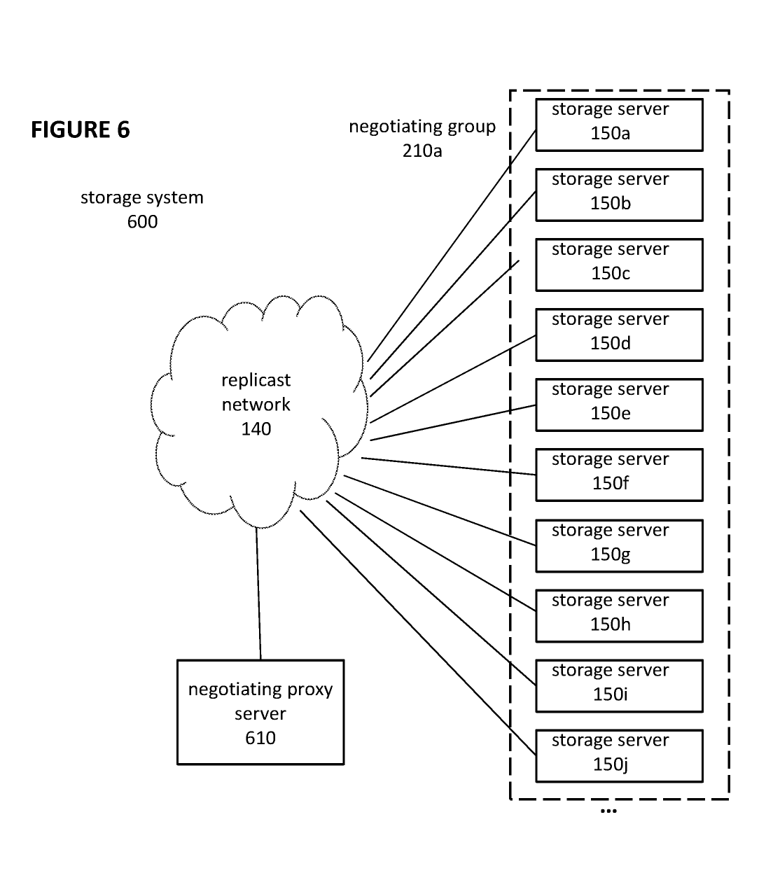

FIG. 6 provides an overview of an embodiment. Storage system 600 comprises clients 110a. . . 110i, client access network 120, and gateway 130 (not shown) as in storage system 100 of FIG. 1. Storage system 600 also comprises replicast network 140 and negotiating group 210a comprising storage servers 150a . . . 150j as in storage system 100 of FIG. 1, as well as negotiating proxy server 610. Negotiating proxy server 610 is coupled to replicast network 140 and receives all control packets sent to or from negotiating group 210a. It is to be understood that replicast network 140, negotiating group 210a, storage servers 150a . . . 150j, and negotiating proxy server 610 are merely exemplary and that any number of such devices can be used. In the preferred embodiment, each negotiating group is associated with a negotiating proxy server that can act in certain circumstances as a proxy on behalf of storage servers within that negotiating group.

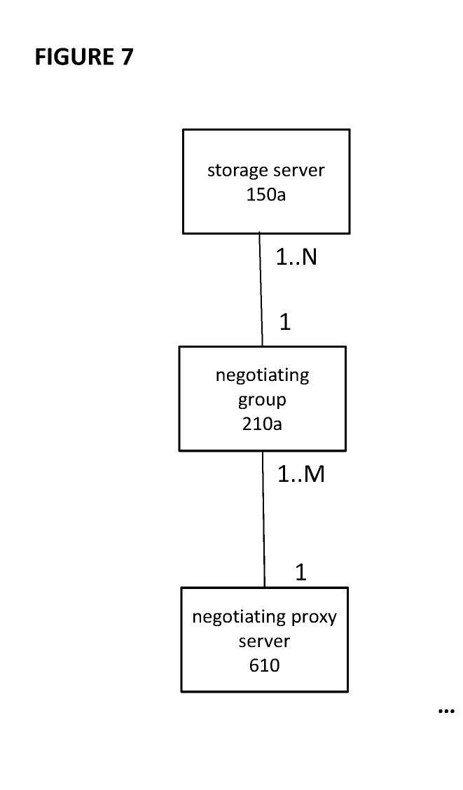

FIG. 7 illustrates the cardinalities of the relationships between the negotiating proxy servers (such as negotiating proxy server 610), negotiating groups (such as negotiating group 210a) and storage servers (such as storage server 150a). Each negotiating proxy server manages one or more negotiating groups. Each negotiating group is served by one negotiating proxy server. Each negotiating group includes one or more storage servers. Each storage server is in exactly one negotiating group.

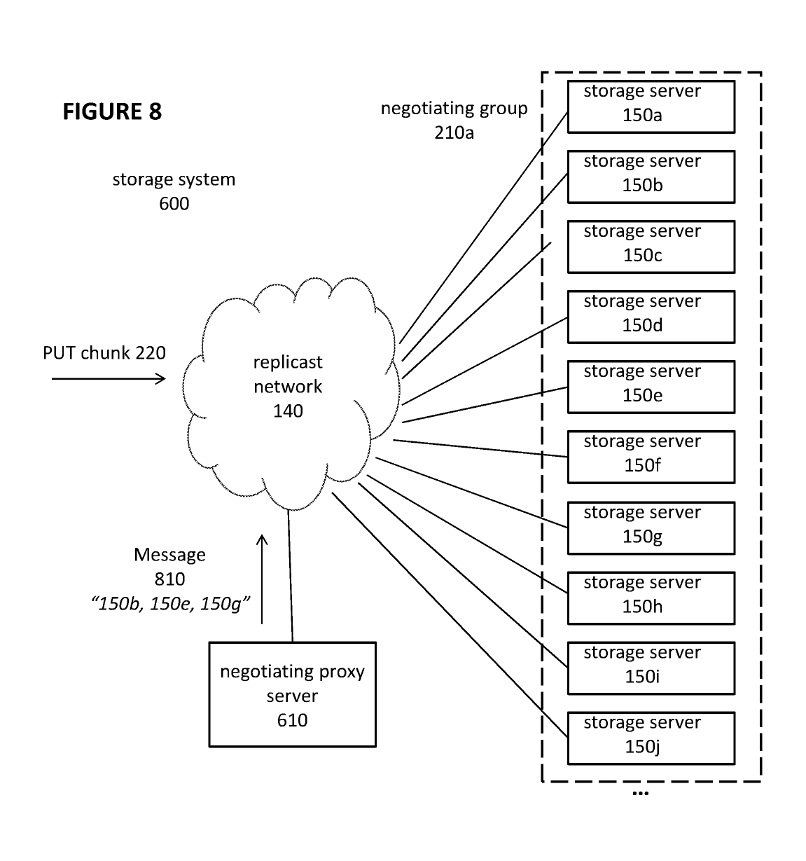

In FIG. 8, a put chunk 220 request is sent by gateway 130 to negotiating group 210a. Negotiating proxy server 610 also receives the request and determines that the request should be handled by storage servers 150b, 150e, and 150g as rendezvous group 310a, and it sends message 810 to gateway 130 with that information. It also sends message 810 to negotiating group 210a so that storage servers 150b, 150c and 150g will expect a rendezvous transfer using rendezvous group 310a at the specified time, and so that all other storage servers in negotiating group 210a will cancel any reservations made for this transaction.

In an alternative embodiment, a multicast group may be provisioned for each combination of negotiating group and gateway. When such a multicast group has been pre-provisioned, message 810 can simply be multicast to this group once to reach both the gateway (such as gateway 130) and the negotiating group (such as negotiating group 210a).

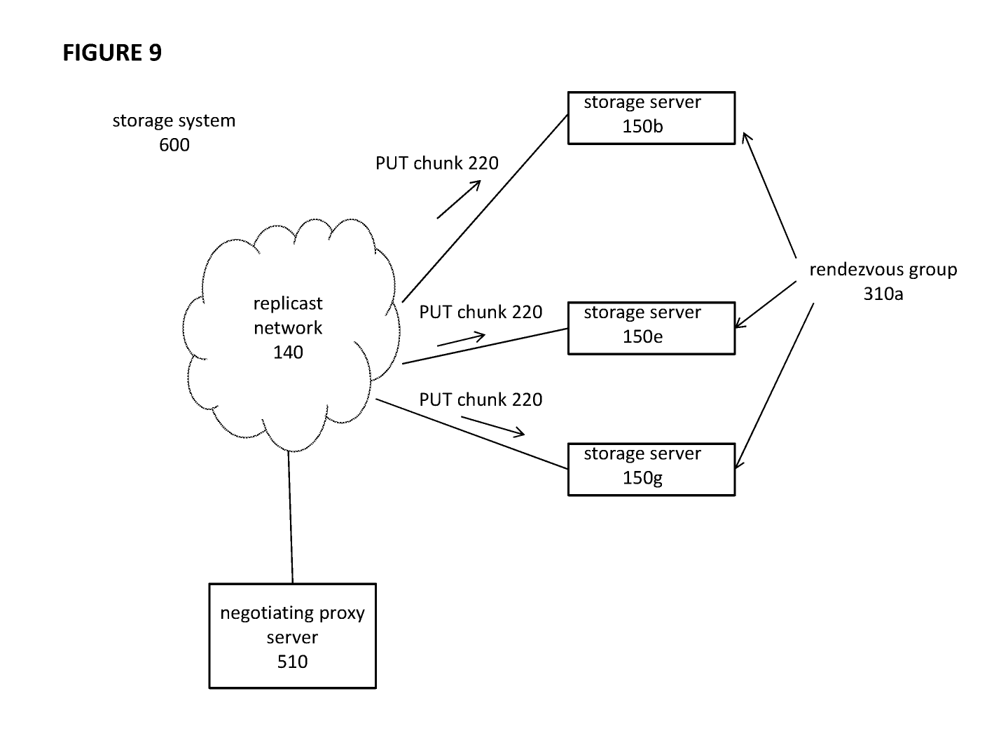

In FIG. 9, once rendezvous group 310a has been established using one of the methods described above, the put transaction for chunk 220 is sent from gateway 130 to storage servers 150b, 150e, and 150g as rendezvous group 310a.

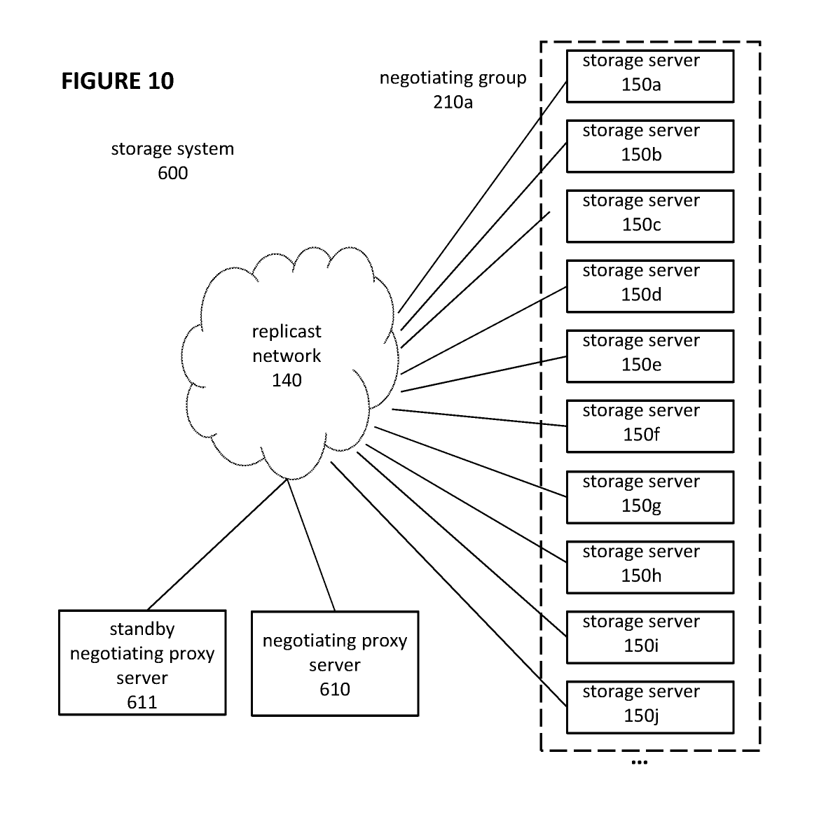

With reference to FIG. 10, storage system 600 optionally can include standby negotiating proxy server 611 in addition to negotiating proxy server 610 configured in an active/passive pair so that standby negotiating proxy server 611 will begin processing requests if and when negotiating proxy server 610 fails.

Operation of Negotiating Proxy Server

Further detail is now provided regarding how negotiating proxy server 610 receives and acts upon control plane messages.

To be an efficient proxy, negotiating proxy server 610 must receive the required control messages without delaying their delivery to the participants in the negotiation (e.g., gateway 130 and storage servers 150a . . . 150k).

Unsolicited messages from gateway 130 are sent to the relevant negotiating group, such as negotiating group 210a. Negotiating proxy server 610 simply joins negotiating group 210a. This will result in a practical limit on the number of negotiating groups that any negotiating proxy server can handle. Specifically, negotiating proxy server 610 typically will comprise a physical port with a finite capacity, which means that it will be able to join only a finite number of negotiating groups. In the alternative, negotiating proxy server 610 can be a software module running on a network switch, in which case it will have a finite forwarding capacity dependent on the characteristics of the network switch.

There are two methods for receiving and acting upon messages from storage servers back to a gateway:
Use an additional multicast address:
   Create a multicast group for each gateway/negotiating proxy server combination. Alternately, this could be for each gateway/negotiating group combination. The latter option would be useful for the “group consensus” strategy.
   Specify this address as a “reply to” field in each unsolicited command sent by the gateway. The gateway would need to track what “reply to” address to use for each negotiating group.
   The negotiating proxy server will now be aware of chunk acks and put responses.
Use port minoring
   Set up L2 (Layer 2) filtering rules so that all non-rendezvous-transfer unicast UDP packets from storage servers to gateways will be replicated to the port for the negotiating group of the sending storage server.
Note that this is problematic if there are multiple switches in the replicast network. It requires the ability to create L2 forwarding rules that are specified as though the N switches with M end-nodes each were actually a single N*M port switch. This is possible, but dependent on the switch model. If a deployment has multiple models of switches the chances of a success plummet rapidly.
   The storage server can now simply unicast reply to the gateway, and the correct negotiating proxy server or servers will receive a copy of the packet.

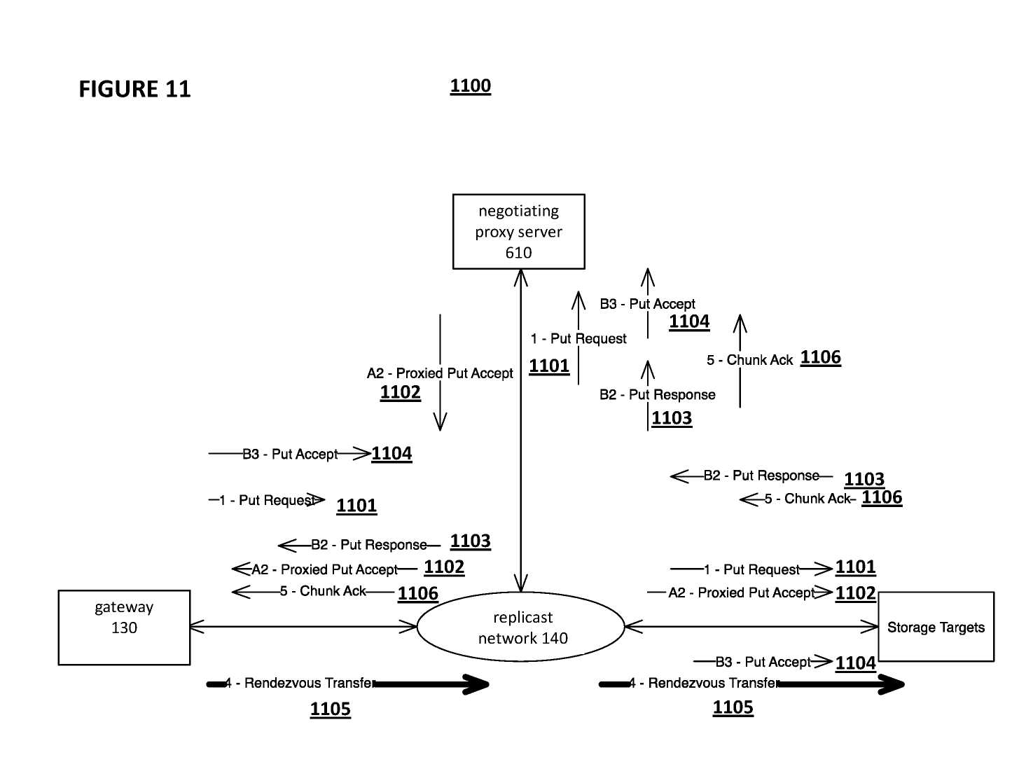

With reference to FIG. 11, additional details of a system and method for implementing negotiating proxy server 610 are disclosed. Gateway 130 negotiates with the storage servers in negotiating group 210a using the basic replicast protocol described above and in the incorporated references. The negotiating proxy server 610 receives the same put requests as the storage servers, but will typically be able to respond more rapidly because:
It never has payload frames in either its input or output links.
It only deals with small packets for a select set of negotiating groups. It is not managing any storage targets of its own.
It may be co-located with a network switch supporting the replicast network.

FIG. 11 details the steps in a put transaction for both the proxied and non-proxied path. The put transaction method 1100 generally comprises: Gateway 130 sends a put request (step 1101). Negotiating proxy server 610 sends a proxied put accept message that identifies the rendezvous group and its constituent storage servers and establishes when the rendezvous transfer will occur. This message is unicast to gateway 130 and multicast to negotiating group 210a. It may also be multicast to a group which is the union of the gateway and the negotiating group. (step 1102). Concurrent with step 1102, each storage server responds with a bid on when it could store the chunk, or if the chunk is already stored on this server. (step 1103). In response to step 1102, no accept message from gateway 130 is needed. In response to step 1103, gateway 130 multicasts a put accept message specifying when the rendezvous transfer will occur and to which storage servers. (step 1104). The rendezvous transfer is multicast to the selected storage servers (step 1105). The selected storage servers acknowledge the received chunk (i.e., the payload) (step 1106).

Negotiating proxy server 610 for a storage cluster can be implemented in different variations, discussed below. With both variations it may be advantageous for the Negotiating proxy server to only proxy put transactions. While get transactions can be proxied, the proxy does not have as much information on factors that will impact the speed of execution of a get transaction. For example, the proxy server will not be aware of which chunk replicas are memory cached on each of their storage server. The storage server that still has the chunk in its cache can probably respond more quickly than a storage server that must read the chunk from a disk drive. The proxy would also have to track which specific storage servers had replicas of each chunk. This would require tracking all chunk puts and replications within the negotiating group.

One variation for negotiating proxy server 610 is to configure it as minimal put negotiating proxy server 611, which seeks to proxy put requests that can be satisfied with storage servers that are known to be idle and does not proxy put requests that require more complicated negotiation. This strategy substantially reduces latencies during typical operation, yet requires minimal put negotiating proxy server to maintain very little data.

The put request is extended by the addition of a “desired count” field. If the desired count field is zero, then negotiating proxy server 610 must not process the request. If the desired count field is non-zero, then the field is used to convey to the negotiating proxy server 610 the desired number of replicas.

Negotiating proxy server 610 will preemptively accept for the requested number of storage servers if it has the processing power to process this request, and it has sufficient knowledge to accurately make a reservation for the desired number of storage servers.

The simple profile for having “sufficient knowledge” is to simply track the number of reservations (and their expiration times) for each storage server. When a storage server has no pending reservations, then negotiating proxy server 610 can safely predict that the storage server would offer an immediate bid.

Negotiating proxy server 610 sends a proxied put accept to the client and to negotiating group. If there is a multicast group allocated to be the union of each gateway and negotiating group, then the message will be multicast to that group. If no such multicast group exists, the message will be unicast to the gateway and then multicast to the negotiating group.

A storage server can still send a put response on its own if it fails to hear the proxied put response, or if it already has the chunk and a rendezvous transfer to it is not needed. In the latter situation, gateway 130 will send a put accept modification message to cancel the rendezvous transfer. Otherwise, the rendezvous transfer will still occur. When the received chunk is redundant, it will simply be discarded.

When the multicasting strategy in use is to dynamically specify the membership of the rendezvous group, the superfluous target should be dropped from the target list unless the membership list has already been set. When the pre-configured groups method is being used, the identified group will not be changed and the resulting delivery will be to too many storage targets. However, it would be too problematic to update the target group in such close proximity to the actual transfer.

The key to minimal put negotiating proxy server 611 is that it tracks almost nothing other than the inbound reservations themselves, specifically:
Which negotiating group;
Which non-deprecated storage server in that negotiating group;
Zero or more inbound reservations: and
Start and stop times.

Note that a minimal put negotiating proxy does not track location of chunk replicas. Therefore, it cannot proxy get transactions.

Another variation for negotiating proxy server 610 is to configure it as nearly full negotiating proxy server 612, which tracks everything that the minimal proxy does, as well as:
Which chunks are stored on which targets;
How deep the write queue is on each target. This can be estimated by tracking all rendezvous transfers to each target versus the amount that has been acknowledged with a chunk ack. This is then compared with a capacity reported by the storage server when it joined the storage cluster;
How deep the output queue is on each target at least in terms of scheduled rendezvous transfers originating from this server, if proxying of get transactions is to be supported; and
How close to capacity the persistent storage is on each storage server. This must be reported as piggy-backed data on chunk acks.

Nearly full negotiating proxy server 612 answers all put requests. It may also answer get requests if it is tracking pending or in-progress rendezvous transmissions from each server. Storage servers still process put or get requests that the proxy does not answer, and they still respond to put requests when they already have a chunk stored.

Another variation for negotiating proxy server 610 is to implement it as front-end storage server 613. The storage servers themselves then only need the processing capacity to perform the rendezvous transfers (inbound or outbound) directed by front-end storage server 613.

Tracking the existence of each replica requires a substantial amount of persistent storage. This likely is unfeasible when negotiating proxy server 610 co-located with switch itself. However, it may be advantageous to have one high power front-end storage server 613 orchestrating N low processing power back-end storage servers. Another advantage of such an architecture is that the low-power back-end storage servers could be handed off to a new front end storage server 613 after the initial front end storage server 613 fails.

Note that front end storage server 613 will not be able to precisely predict potential synergies between write caching and reads. It will not be able to pick the storage server that still has chunk X in its cache from a put that occurred several milliseconds in the past. That information would only be available on that processor. There is no effective method of relaying that much information across the network promptly enough without interfering with payload transfers.

Storage Server Preemption

When deployed in a storage cluster that may include a negotiating proxy server 610, it is advantageous for a storage server to “peak ahead” when processing a put request to see if there is an already-received preemptive put accept message waiting to be processed. When this is the case, the storage server should suppress generating an inbound reservation and only generate a response if it determines that the chunk is already stored locally.

Further, it may be advantageous for a storage server to delay its transmission of a put response when its bid is poor. As long as its bid is delivered before the transactional timeout and well before the start of its bid window, there is little to be lost by delaying the response. If this bid is to be accepted, it does not matter whether it is accepted 2 ms before the rendezvous transfer or 200 ms before it. The transaction will complete at the same time.

However, delaying the response may be efficient if the response ultimately is preempted put accept message when other targets have been selected by the gateway or the negotiating proxy server.

Exemplary Control Sequences for Storage Servers

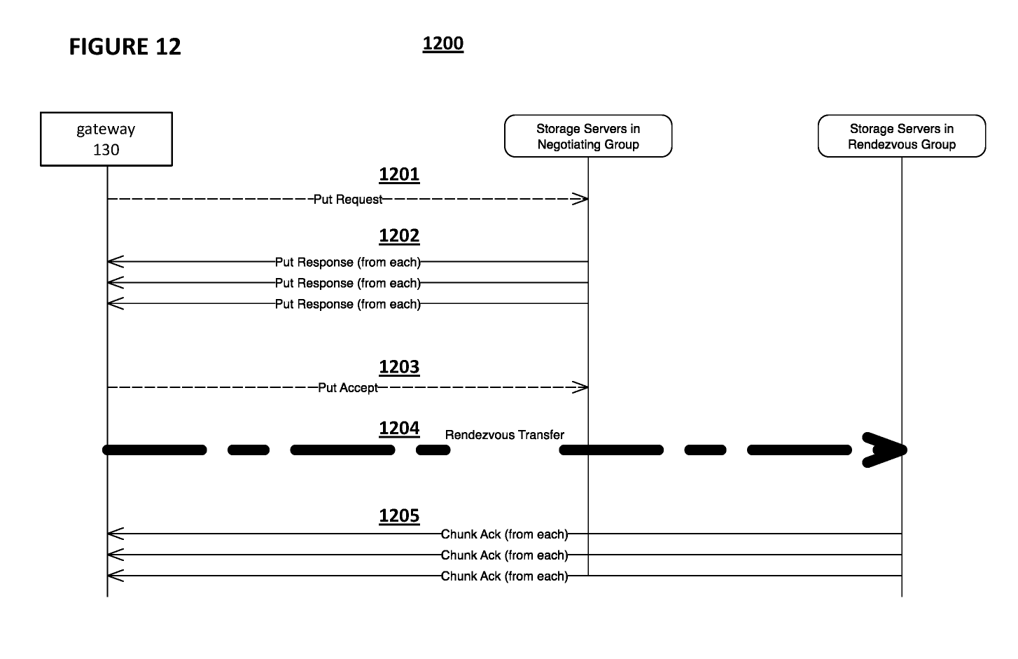

FIGS. 12-14 depict exemplary control sequences involving exemplary storage system 600. In FIGS. 12-14, multicast messages are shown with dashed lines, payload transfers are shown with thick lines, and control messages are shown with thin lines.

FIG. 12 depicts an exemplary put transaction 1200 without the use of negotiating proxy server 610. Gateway 130 sends a put request to negotiating group 210a (multicast message 1201). Each storage server in negotiating group 210a sends a put response to gateway 130 (control message 1202). Gateway 130 then sends a put accept identifying three storage servers that will receive the put (multicast message 1203). Gateway 130 then sends the rendezvous transfer to the three selected storage servers in negotiating group 210a (payload transfer 1204). The three selected storage servers send a chunk ack to gateway 130 (control message 1205).

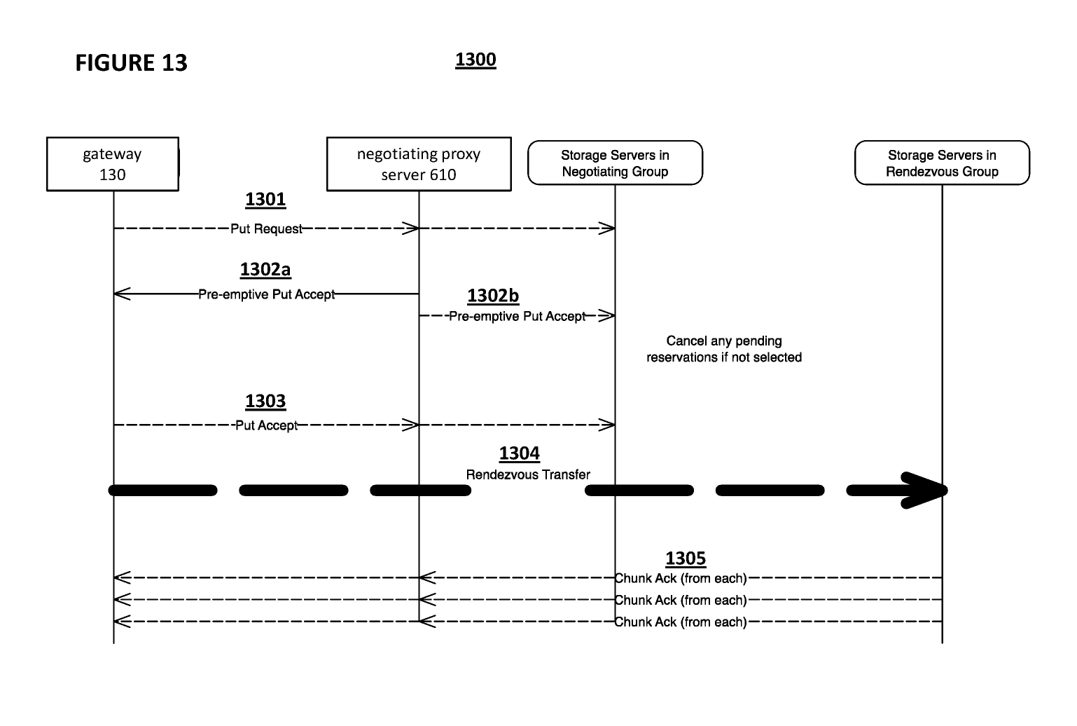

FIG. 13 depicts an exemplary put transaction 1300 where negotiating proxy server 610 pre-empts put responses from storage servers. Gateway 130 sends a put request to negotiating group 210a (multicast message 1301) which includes negotiating proxy server 610. Negotiating proxy server 610 sends a preemptive put accept to gateway 130 and negotiating group 210a accepting the put request on behalf of n storage servers (typically three) in negotiating group 210 (control message 1302a and multicast message 1302). Gateway 130 optionally sends a put accept message confirming that the three selected storage servers will service the put request to negotiating proxy server 610 and negotiating group 210a (multicast message 1303). Gateway 130 then sends the rendezvous transfer to the three selected storage servers in negotiating group 210a (payload transfer 1304). The three selected storage servers send a chunk Ack to gateway 130 (control message 1305).

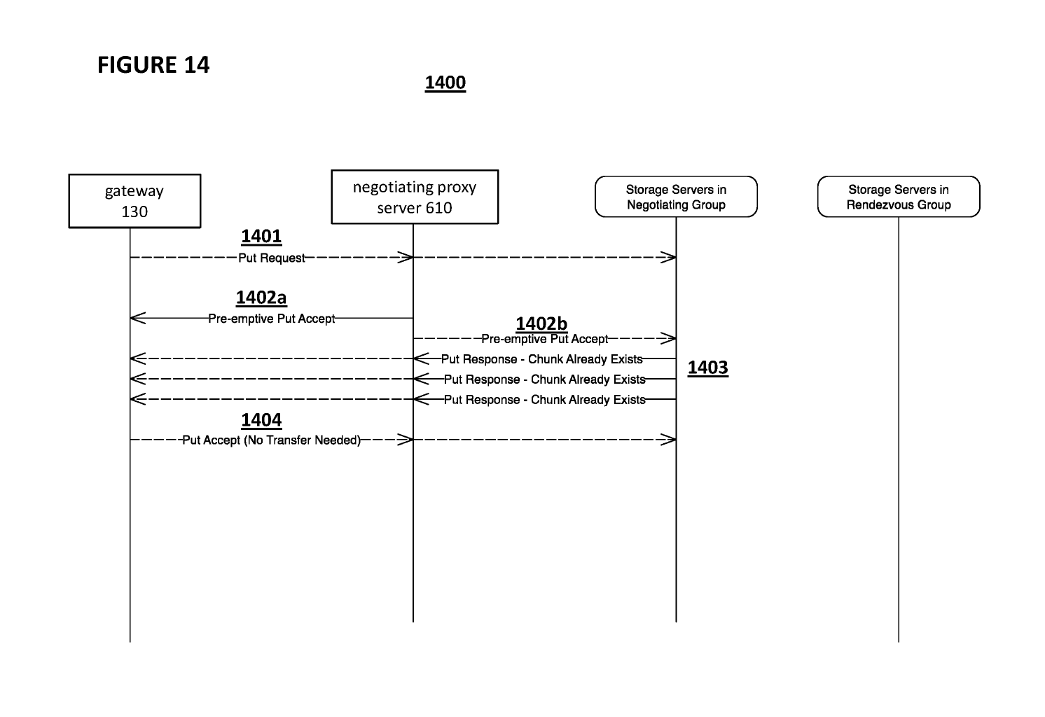

FIG. 14 depicts an exemplary put transaction 1400 with duplicate override. Gateway 130 sends a put request to negotiating proxy server 610 and negotiating group 210a (multicast message 1401). Negotiating proxy server 610 sends a preemptive put accept to gateway 130 and negotiating group 210a accepting the put request on behalf of three storage servers in negotiating group 210 (control message 1402a and multicast message 1402b). In this scenario, three storage servers in negotiating group 210a already have stored the chunk that is the subject of the put request, and they therefore send a put response indicating to negotiating proxy server 610 and gateway 130 that the chunk already exists (multicast message 1403). Gateway 130 sends al put accept message confirming that the put already has been performed and indicating that no rendezvous transfer is needed (multicast message 1304).

Exemplary Control Sequences for General Case

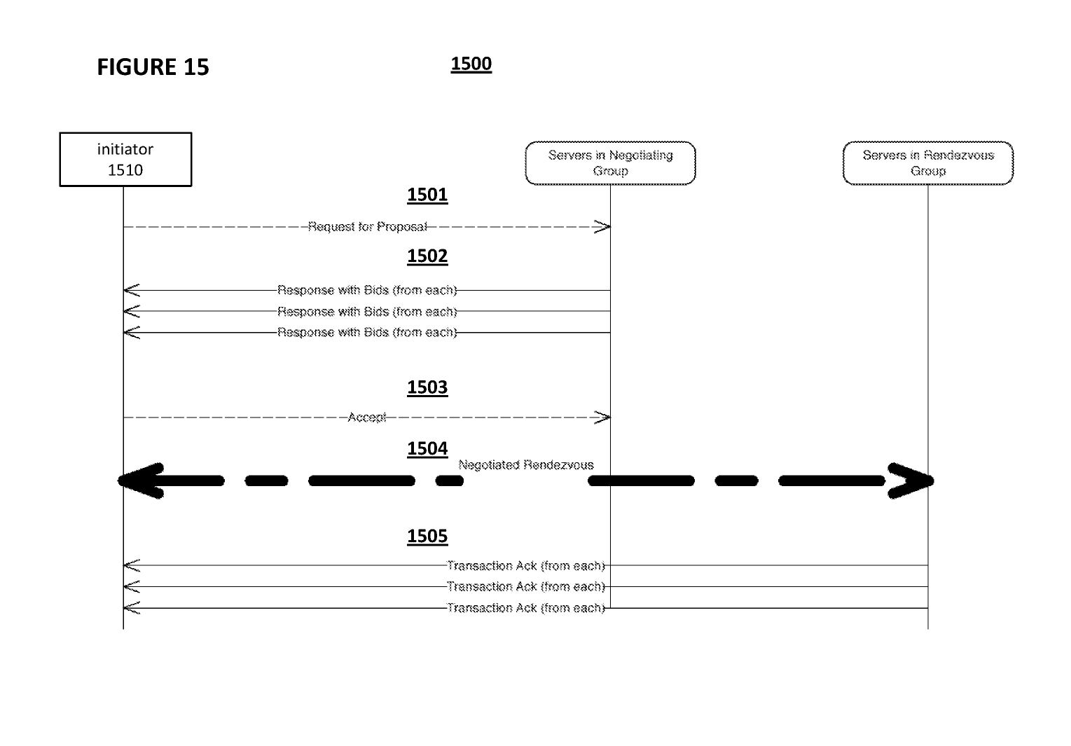

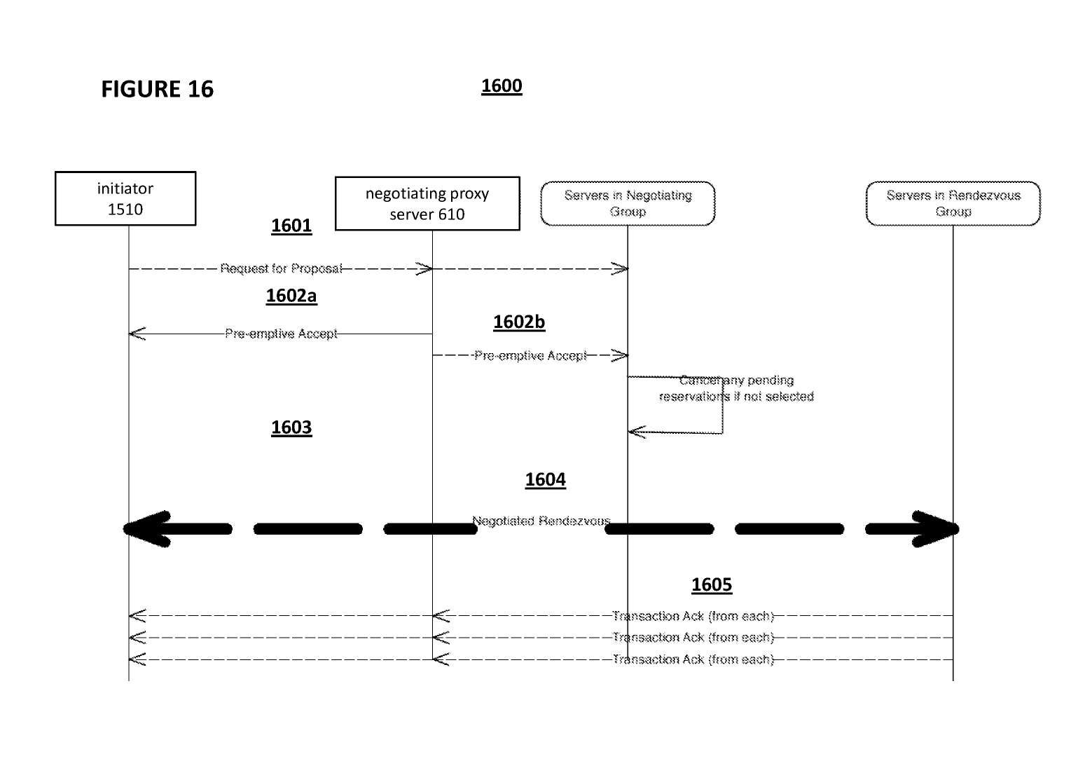

FIGS. 15-16 depict exemplary control sequences for a generic system using multicast negotiations.

FIG. 15 depicts a generic multicast interaction 1500 of the type that the present invention addresses.

In the first step, one of a plurality of independent initiators 1510 multicasts a request for proposal message to a negotiating group (step 1501). Within this application, an “initiator”, a “gateway” (or “application layer gateway” or “storage gateway”) all refer to the same types of devices.

Each member of that group will then respond with bids offering one or more offers to fulfill/contribute to the request (step 1502).

After collecting these responses, the initiator 1510 multicasts an accept message with a specific plan of action calling for specific servers in the negotiating group to perform specific tasks at specific times as previously bid. The servers release and/or reduce the resource reservations made in accordance with this plan of action. (step 1503).

Next the rendezvous interactions enumerated in the plan of action are executed (step 1504).

Finally, each server sends a transaction acknowledgement to the Initiator to complete the transaction (step 1505).

In FIG. 16, a negotiating proxy server is introduced which drafts a plan of action based on its retained information on the servers in the negotiating group, shortcutting the full negotiating process.

In the first set of transaction 1600, an initiator sends a request to negotiating proxy server 610 and negotiating group 210a (multicast message 1601). Negotiating proxy server 610 sends a preemptive accept to the initiator 130 and negotiating group 210a accepting the request on behalf of three storage servers in negotiating group 210 (control message 1602a and multicast message 1602). The initiator sends an accept message confirming that the three selected storage servers will service the put request to negotiating proxy server 610 and negotiating group 210a (multicast message 1603). Initiator then sends the rendezvous transfer to the three selected storage servers in negotiating group 210a (payload transfer 1604). The three selected storage servers send a transaction acknowledge to the initiator (control message 1605).

In an alternative embodiment, the initiator can specify criteria to select a subset of servers within the negotiating group to participate in the rendezvous transaction at a specific time, wherein the subset selection is based upon the negotiating proxy server tracking activities of the servers in the negotiating group. The criteria can include: failure domain of each server in the negotiating group, number of participating servers required for the transaction, conflicting reservations for rendezvous transactions, and/or the availability of persistent resources, such as storage capacity, for each of the servers. The negotiating proxy server can track information that is multicast to negotiating groups that it already subscribes to which detail resource commitments by the servers within the negotiating group.

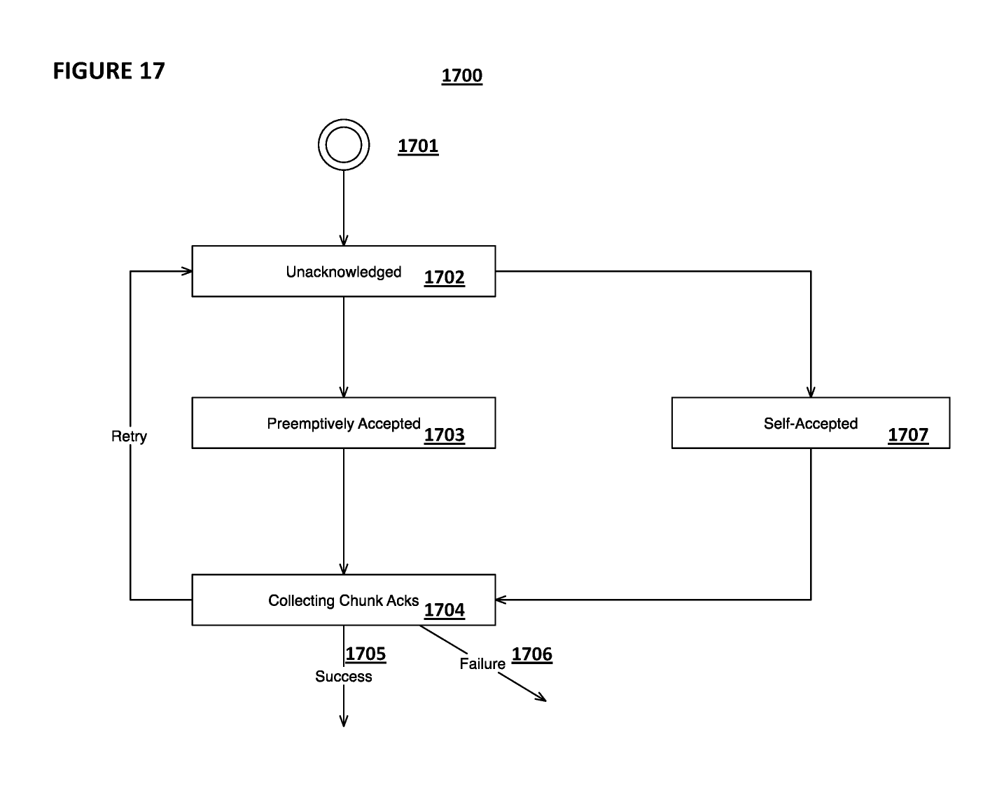

FIG. 17 depicts state diagram 1700 for a put transaction from the perspective of initiator 130. A put request is multicast by gateway 130 to negotiating group 150 in state 1701. Initiator 130 then immediately enters unacknowledged state 1702. In this state, one of the following will occur:
After a timeout, the put request will be retransmitted up to (configurable) N times before the transaction fails (state 1706). If not enough put responses were collected (as compared against the desired number of replicas), a put accept should be multicast to the negotiating group to decline the offered bids.
A preemptive accept may be received from a negotiating proxy server 610, which transitions initiator 130 to preemptively accepted state 1702.
A sufficient number of put responses may be collected from storage servers. A put accept is then multicast to negotiating group 210a placing initiator 130 in self-accepted state 1706.

In preemptively accepted state 1702, a preemptive accept has been received for the chunk put transaction. During this state, initiator 130 is expected to multicast the rendezvous transfer at the accepted time to the specified rendezvous group. However, initiator 130 may receive put responses from storage servers despite the negotiating proxy server's preemption. If these indicate that the chunk is already stored, the responses should be counted to see if the rendezvous transfer is no longer needed.

If a rendezvous transfer is still needed (for example, if three replicas are required and two storage servers indicate that they are already storing the chunk), then, if possible, the storage server or storage servers that are already storing the chunk should be removed from the rendezvous group so that the chunk is stored on a different storage server. However, this would require TSM or BIER style multicasting where the membership of the rendezvous group is dynamically specified, rather than the rendezvous group being dynamically selected, and this will not be possible in most embodiments.

If sufficient responses are collected and the initiator 130 concludes a rendezvous transfer is not needed, then it will multicast a put accept modification message to cancel the rendezvous transfer.

After the rendezvous transfer has completed or been cancelled the transaction shifts to the collecting acks state 1703.

Self-accepted state 1706 is similar to preemptively accepted state 1702. The main differences are the set of spurious responses which may be treated as suspicious. For example, more than one response from any given storage server indicates a malfunctioning storage server.

A preemptive put accept is ignored after the initiator has issued its own put accept. It may be advantageous to log this event as that it is indicative of an under-resourced or misconfigured proxy.

The collecting ack state 1703 is used to collect the set of chunk acks, positive or negative, from the selected storage servers. This state may be exited once sufficient positive acknowledgements have been collected to know that the transaction has completed successfully (success 1704). However, later acknowledgements must not be flagged as suspicious packets.

When insufficient positive acknowledgements are received during a configurable transaction maximum time period limit, a retry will be triggered unless the maximum number of retries has been reached.

Special Cases

These sections will describe handling of special cases.

a. Dropped Packets

As with all replicast transactions, dropped packets will result in an incomplete transaction. The CCOW (cloud copy on write) layer in gateway/initiator 130 will note that the required number of replicas has not been created and it will retry the put transaction with the “no-proxy” option set.

This recovery action can be triggered by loss of command packets, such as the preemptive accept message, as well as loss of payload packets.

b. Duplicate Chunks

Negotiating proxy server 610 will preemptively respond to a put request if all conditions are met regardless of whether the chunk is already stored in the cluster.

When this occurs, the following sequence of interactions will occur:

1. Initiator/Gateway 130 multicasts a put request.

2. Negotiating proxy server 610 responds with proxied put response

3. Storage servers respond with “chunk already stored” put response

4. What happens next depends on when gateway 130 processes the chunk already stored responses.
Gateway 130 may process them before sending a chunk accept. In this case, gateway 130 will not schedule a rendezvous transfer. All incoming reservations will be cancelled.
Gateway 130 may process them after sending the chunk accept but before initiating the rendezvous transfer. In this case, gateway 130 will send a chunk accept modification and cancel the rendezvous transfer.
Gateway 130 may process them after already initiating the rendezvous transfer. It this case, gateway 130 may simply abort the rendezvous transfer and ignore the chunk negative ack that it will receive from each of the selected targets.

c. Deprecated Storage Targets

Negotiating proxy server 610 must not select a storage target that has been declared to be in a deprecated state. A storage server may deprecate one of its storage targets declaring it to be ineligible to receive new content. This is done when the storage server fears the persistent storage device is approaching failure.

In addition to the existing reasons for a storage server to declare a storage target to be ineligible to accept new chunks, the storage server may inform the negotiating proxy server 610 that it should not proxy accept for one of its storage devices. This could be useful when the write queue is nearly full or when capacity is approaching the maximum desired utilization. By placing itself on a “don't pick me automatically” list, a storage server can make itself less likely to be selected, and thereby distribute the load to other storage servers.

Processing Load

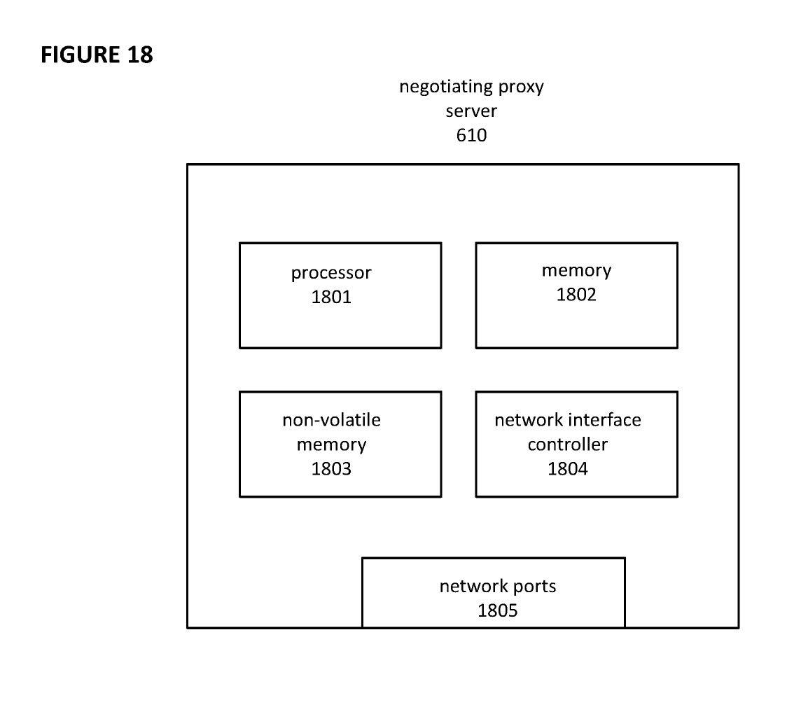

FIG. 18 depicts basic hardware components of one embodiment of a negotiating proxy server 610. In its simplest form, negotiating proxy server 610 comprises processor 1801, memory 1802, optional non-volatile memory 1803 (such as a hard drive, flash memory, etc.), network interface controller 1804, and network ports 1805. These components can be contained within a physical server, a network switch, a network router, or other computing device.

Each negotiating proxy server 610 will be configured to handle N negotiating groups. Typically, each negotiating proxy server 610 will be limited to a 10 Gb/sec bandwidth (based on the bandwidth of network ports 1805) even if it is co-located with a switch.

The processing requirements for negotiating proxy server 610 for any given packet are very light. During operation, processor 1801 will perform the following actions based on software stored in memory 1802 and/or non-volatile memory 1803:
For a put request:
   Lookup pending reservation count for M members of negotiating group 210a, where M is an integer equal to or less than the number of storage servers in the negotiating group. Determine if any reservations have completed.
   If there are at least N with zero then randomly select N and issue the preemptive response to the client and to negotiating group 210a, where N is an integer equal to or less than M.
   Record the reservation preemptively made for the N targets.
For a put response (if multicast by the storage servers)
   Create the tentative reservation.
For an accept request:
   Create or modify the inbound reservation for the accepted targets.
   Eliminate tentative reservations for non-accepted targets.

The processing and memory requirements required for these actions are very low, and if processor 1801 can handle the raw 10 Gb/sec incoming flow, then this application layer processing should not be a problem. It may be advantageous to improve latency by limiting each negotiating proxy server 610 to handle less data than is potentially arriving in network ports 1805. Handling fewer negotiating groups will improve the responsiveness of negotiating proxy server 610. The optimal loading is a cost/benefit tradeoff that will be implementation and deployment specific.

Negotiating proxy server 610 is functionally different than a storage metadata server that schedules the actions of block or data servers, such as found in pNFS or HDFS. The block or data servers in those systems are totally under the control of the metadata server. They are never engaged in work which the metadata server did not schedule, As such the metadata server is not functioning as a proxy for them, but rather as their controller or master.

Additional Benefits of Embodiments

These sections will describe benefits of the present invention.

Negotiating proxy server 610 does not delay any communications between the default partners in the replicast put negotiation (i.e., the gateway and the storage servers in the addressed negotiating group). Therefore it can never have a negative impact. It might be a total waste of resources, but it cannot slow the cluster down.

The activities of negotiating proxy server 610 are purely optional. If they speed up a transaction, they provide a benefit. If they do not, the transaction will still complete anyway.

Negotiating proxy server 610 cannot delay the completion of the replicast put negotiation, and in many cases will accelerate it.

When there are no current inbound reservations for replica count storage targets in the negotiating group, this will result in the rendezvous transfer beginning sooner, and therefore completing sooner. This can improve average transaction latency and even cluster throughput.

When a storage server makes a bid in a put response, it must reserve that inbound capacity until it knows whether its bid will be accepted or not. When it intercedes on a specific negotiation, the negotiating proxy server 610 short-circuits that process by rapidly letting all storage servers. This can be substantially earlier. Not only is the round-trip with the storage gateway avoided, but also the latency of processing unsolicited packets in the user-mode application on the gateway. The gateway may frequently have payload frames in both its input and output queues, which can considerably increase the latency in it responding to a put response with a put accept.

The resource reservations created by a preemptive accept are limited to the subset of servers satisfying the corresponding selection criteria (e.g., a number of servers required), and only for the duration required. A tentative reservations offered by a storage server is a valid reservation until the accept message has been received. Limiting the scope and duration of resource reservations allows later transactions to make the earliest bids possible.

What is claimed is:

1. A method of optimizing a multicast negotiation to synchronize the timing of a rendezvous transaction between an initiator and a subset of servers in a multicast group, the method comprising:
an initiator issuing a multicast request to a multicast group and specifying criteria to select a subset of servers within the multicast group to participate in a rendezvous transaction at a specific time;
a negotiating proxy server responding to the multicast request by issuing a preemptive accept message to the multicast group and the initiator, the preemptive accept message specifying a subset of servers based on the criteria and tracking information derived from activities of servers in the multicast group.

2. The method of claim 1, wherein the negotiating proxy server participates only in control plane communications and never receives nor transmits any data plane payload.

3. The method of claim 1 wherein the criteria comprises one or more of:
failure domain of each server in the negotiating group;
number of participating servers required for the transaction;
conflicting reservations for rendezvous transactions; and
availability of persistent resources for each server.

4. The method of claim 1, wherein the preemptive accept message is unicast to the initiator and multicast to the multicast group.

5. The method of claim 1, wherein the preemptive accept message is multicast to a group that comprises members of the multicast group and the initiator.

6. The method of claim 1, wherein the tracking information comprises resource commitments by the servers within each multicast group to which the negotiating proxy server subscribes.

7. The method of claim 6, wherein the tracking information comprises information derived for each member of the multicast group from analyzing control plane traffic multicast to the multicast group, the information comprising:
a set of offered or confirmed time windows for participating in rendezvous transactions which have not yet expired; and
whether a server has requested the negotiating proxy server to refrain from negotiating on its behalf until a specified time.

8. A method for allocating storage resources, comprising:
accepting, by an initiator, a preemptive accept message from a negotiating proxy server that establishes a rendezvous transaction to be performed, the rendezvous transaction comprising storing content on N storage servers, where N is an integer;
if M storage servers, where M<N, respond with a message indicating the content is already stored on the storage server, then sending the content to be stored on N-M storage servers; and
if N storage servers or more respond with a message indicating the content is already stored on each storage server, then canceling the rendezvous transaction.

9. The method of claim 8, further comprising sending a multicast modified accept message when sending the content to be stored on N-M storage servers.

10. A method for allocating resources in a cluster, comprising:
accepting, by an initiator, a preemptive accept message sent by a negotiating proxy server in response to a multicast request, wherein the accepting establishes a transaction to be performed;
ignoring, by the initiator, any received bids to perform the transaction; and
analyzing, by the initiator, any received messages to determine if the transaction should be cancelled.

11. The method of claim 10, wherein the cluster is a storage cluster and the method further comprises:
canceling the transaction in response to a message that content to be stored as part of the transaction is already stored on a storage server in the cluster.

12. The method of claim 10, wherein the cluster is a compute cluster and the method further comprises:
canceling the transaction in response to a message that a task to be performed as part of the transaction has already been performed by another server in the cluster.

13. A method of allocating computing resources in a storage cluster comprising storage servers and negotiating proxy servers, comprising:
evaluating, by each storage server in the storage cluster, all received commands in its input queues before responding to a received put request to determine if the input queues contain a preemptive put accept message sent by a negotiating proxy server in response to the put request.

14. A method for allocating storage resources in a storage system comprising a negotiating proxy server and a plurality of storage servers, the method comprising:
receiving, by a storage server, a preemptive accept message sent by the negotiating proxy server in response to a put request to store a chunk;
cancelling, by the storage server, any pending resource reservations made by the storage server for the put request;
if the storage server is identified in the preemptive accept message, creating a pending resource reservation for a time window indicated in the preemptive accept message.

15. The method of claim 14 further comprising:
if the chunk is already stored by the storage server, the storage server sending a message indicating that the storage server has already stored the chunk.

16. A method of allocating resources in a cluster, the method comprising:
tracking, by a negotiating proxy server, activities of servers in a multicast group to generate tracking information;
receiving, by a negotiating proxy server, a multicast request from an initiator to the multicast group; and
responding, by the negotiating proxy server, to the multicast request by issuing a preemptive accept message to the multicast group and the initiator, the preemptive accept message specifying a subset of servers in the multicast group based on the tracking information to perform the task indicated in the multicast request.

17. The method of claim 16, wherein the tracking information comprises information about multicast communications for the multicast group.

18. The method of claim 16, wherein the tracking information comprises information regarding scheduled rendezvous transactions.

19. The method of claim 18, wherein the tracking information further comprises information that indicates resource commitments by servers within the multicast group.

20. The method of claim 16, wherein at least some of the tracking information is derived from control plane traffic comprising one or more of:
a set of offered or confirmed time windows for participating in rendezvous transactions which have not yet expired; and
a request by a server that the negotiating proxy server refrain from negotiating on behalf of the server until a specified time.

21. The method of claim 16, wherein the tracking information comprises:
the aggregate size of content accepted by each storage server in the negotiating group which has not yet been acknowledged; and
the maximum capacity for unacknowledged content for each storage server in the negotiating group.

22. A storage system, comprising:
a plurality of clients;
a plurality of gateways, each gateway coupled to the plurality of clients over a first network;
a plurality of storage servers coupled to the gateways over second network;
a plurality of sets of storage devices, wherein each of the plurality of storage servers is coupled to a set of storage devices; and
a negotiating proxy server coupled to the replicast network, wherein the negotiating proxy server receives control messages sent by the gateway to one or more of the plurality of storage servers but does not receive payload transfers sent by the gateway to one or more of the plurality of storage servers, and wherein the negotiating proxy server receives control messages sent by the one or more of the plurality of storage servers to the gateway but does not receive payload transfers sent by the one or more of the plurality of storage servers to the gateway.

23. The storage system of claim 22, wherein the second network comprises a replicast network.

24. The storage system of claim 22, wherein the negotiating proxy server is configured to receive a put request and to issue a preemptive accept message in response to the put request, the preemptive accept message comprising an identification of a subset of storage servers within the plurality of storage servers to handle the put request, and information relating to the time when the put request will be executed.

25. The storage system of claim 22, wherein the negotiating proxy server is configured to store tracking information comprising:
the aggregate size of content accepted by each storage server in a negotiating group which has not yet been acknowledged; and
the maximum capacity for unacknowledged content for each storage server in the negotiating group.

26. The storage system of claim 24, wherein the put request is a multicast put request.

27. The storage system of claim 26, wherein the negotiating proxy server is configured to analyze all multicast traffic for a negotiating group and to track rendezvous transactions scheduled for all storage servers in the negotiating group.

28. The storage system of claim 24, wherein the preemptive accept message is addressed to the gateway and all members of a negotiating group either as a multicast message sent to a multicast group comprising the gateway and all members of the negotiating group or as a unicast message to the gateway and a multicast message to the negotiating group.
